(19) United States
(12) Patent Application Publication
(10) Pub. No.: US 2004/0060550 A1
(43) Pub. Date: Apr. 1, 2004

(54) Auto-calibration method for a wide range exhaust gas oxygen sensor

(76) Inventors: Ming-Cheng Wu, Rochester Hills, MI (US); Andrew P. Bagnasco, Plymouth, MI (US); Paul Casey Kikuchi, Fenton, MI (US)

Correspondence Address: VINCENT A. CICHOSZ, DELPHI TECHNOLOGIES, INC., Legal Staff, Mail Code: 480-410-202, P.O. Box 5052, Troy, MI, 48007-5052, US

(21) Appl. No.: 10/260,750

(22) Filed: Sep. 30, 2002

(51) Int. Cl. F02D 41/14

(52) U.S. Cl. 123/694

(57) ABSTRACT

A stored relationship between air/fuel ratio and the output voltage of a wide-range exhaust gas oxygen sensor is automatically re-calibrated under any air/fuel ratio condition. Once an engine control module records oxygen sensor voltages under stoichiometric and deceleration fuel cut-off conditions, the air/fuel ratio that corresponding to any sensor voltage can be calculated. In operation, the sensor voltage recorded during fuel cut-off is used to determine first and second lump-sum parameters that relate sensor output voltage to air/fuel ratio under lean and rich operating conditions, respectively. The determined parameters are compared with previously determined values, and when the comparison indicates that at least a predetermined change the sensor operating characteristics has occurred, the parameters are used to re-calibrate the stored sensor voltage vs. air/fuel ratio relationship.

### TECHNICAL FIELD

This invention relates to closed-loop fuel control of an internal combustion engine having a wide range oxygen sensor installed in its exhaust gas stream, and more particularly a control method for periodically and automatically calibrating the wide range oxygen sensor.

### BACKGROUND OF THE INVENTION

Effective emission control of internal combustion engine exhaust gases with a catalytic converter requires precise control of the air/fuel ratio supplied to the engine cylinders. For this purpose, it is customary to install an oxygen sensor in the engine exhaust stream, and to use the sensor output as a feedback signal for closed-loop fuel control.

In general, two different types of oxygen sensors are available for usage in automotive fuel control. The most common and least expensive sensor, referred to as a switching sensor, has a bi-stable output voltage that switches or toggles between first and second states corresponding to lean and rich conditions of the sensed exhaust gas, relative to a stoichiometric air/fuel ratio of approximately 14.7:1 for pump gasoline. The other type of oxygen sensor, referred to as a wide-range or universal exhaust gas oxygen sensor, has an analog output that varies in amplitude in relation to the deviation of the sensed exhaust gas from the stoichiometric air/fuel ratio. While switching sensors are relatively inexpensive, wide range sensors are being increasingly used in automotive applications, particularly in direct injection or stratified charge engines where the air/fuel ratio can be maintained well above the stoichiometric ratio.

The relationship between air/fuel ratio and the output voltage of a wide-range oxygen sensor is initially determined by an off-line factory calibration procedure, and a look-up table or model representative of the determined relationship is programmed or stored in the memory of a microprocessor-based engine control module (ECM). In subsequent engine operation, the ECM reads the sensor voltage and uses the table or model to determine the corresponding air/fuel ratio for purposes of closed-loop fuel control. Unfortunately, however, there is some part-to-part variability, and the sensor characteristics tend to drift with age, leading to fuel control errors since the one-time calibration cannot account for such changes. For this reason, it has been proposed to utilize an auxiliary switching sensor to verify the existence of a steady-state stoichiometric operating condition, and to calculate a look-up table offset so that the air/fuel ratio based on the wide-range sensor also indicates the existence of a stoichiometric operating condition. A more sophisticated approach is described by Kainz in the U.S. Pat. No. 6,227,033, issued on May 8, 2001, assigned to the assignee of the present invention, and incorporated herein by reference. In Kainz, the sensor output voltages that occur under two different operating conditions where the air/fuel ratio is otherwise known are recorded and used to adjust or reconstruct the calibration look-up table so that it coincides with the recorded voltages. One of the operating conditions occurs during steady state stoichiometric operation as described above, while the other operating condition occurs during a so-called “free air” state where the engine is decelerating with the fuel supply cut off.

While the technique described in Kainz represents a significant improvement over simple stoichiometric calibration, the accuracy of the resulting re-calibration is limited because it is based on only two points of the look-up table. Additionally, the sensor behavior observed during fuel cut-off is not directly applicable to sensor behavior under rich air/fuel operating conditions. This is because the sensor is responsive to the partial pressure of oxygen under lean air/fuel ratio operating conditions, and to the partial pressure of reducing gases (CO and H₂) under rich air/fuel ratio operating conditions. Accordingly, what is needed is a method of accurately re-calibrating the sensor voltage vs. air/fuel ratio table for any air/fuel ratio operating condition.

### SUMMARY OF THE INVENTION

The present invention is directed to an improved method of automatically re-calibrating a stored relationship between air/fuel ratio and the output voltage of a wide-range exhaust gas oxygen sensor under any air/fuel ratio condition. Once the engine controller records sensor voltages under stoichiometric and deceleration fuel cut-off conditions, the method of the present invention enables the controller to calculate the air/fuel ratio corresponding to any sensor voltage. According to the invention, the sensor voltage recorded during fuel cut-off is used to determine first and second lump-sum parameters that relate sensor output voltage to air/fuel ratio under lean and rich operating conditions, respectively. The determined parameters are compared with previously determined values, and when the comparison indicates that at least a predetermined change the sensor operating characteristics has occurred, the parameters are used to re-calibrate the stored sensor voltage vs. air/fuel ratio relationship.

### BRIEF DESCRIPTION OF THE DRAWINGS

FIG. 1 is a schematic diagram of an internal combustion engine and exhaust system according to this invention, including a microprocessor-based engine control module, a wide-range oxygen sensor and a switching oxygen sensor.

FIG. 2 is a graph illustrating a look-up table of air/fuel ratio vs. output voltage of the wide-range oxygen sensor of FIG. 1.

FIG. 3 is a flow diagram representative of computer program instructions executed by the engine control module of FIG. 1 in carrying out the sensor calibration method of this invention.

FIG. 4 is a flow diagram detailing a portion of the flow diagram of FIG. 3 pertaining to look-up table re-calibration.

### DESCRIPTION OF THE PREFERRED EMBODIMENT

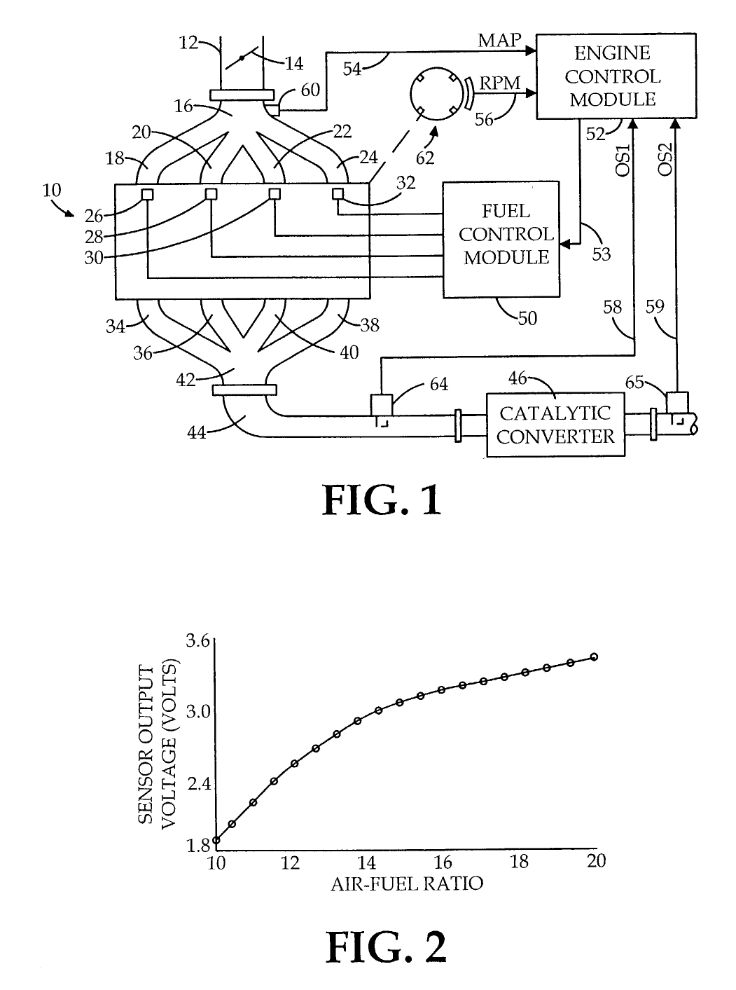

Referring to the drawings, and particularly to FIG. 1, the reference numeral 10 generally designates an automotive four-cylinder internal combustion engine. Engine 10 receives intake air through an intake passage 12 that is variably restricted by a moveable throttle valve 14. Downstream of throttle valve 14, the intake air enters an intake manifold 16 for distribution to the individual engine cylinders (not shown) via a plurality of intake runners 18-24. The fuel injectors 26-32 are positioned to deliver a predetermined quantity of fuel to each intake runner 18-24 for combination with the intake air and admission to respective engine cylinders for combustion therein. Alternatively, engine 10 may be configured for direct injection, in which case the fuel injectors 26-32 inject fuel directly into the engine cylinders. In either case, the combustion products from each cylinder are exhausted into respective exhaust runners 34-40 of an exhaust manifold 42, and combined in an exhaust pipe 44, which in turn, is coupled to a catalytic converter 46 for emission control purposes.

The fuel injectors 26-32 are electrically activated by a fuel control module 50 under the control of a microprocessor-based engine control module (ECM) 52. Specifically, the ECM 52 develops a fuel command pulse width, or injector on-time, for each of the engine cylinders, and provides the pulse width commands to fuel control module 50 via line 53, and the fuel control module 50 activates the injectors 26-32 accordingly. The fuel pulse widths are determined in response to a number of inputs, including a manifold absolute pressure (MAP) signal on line 54, an engine speed (RPM) signal on line 56, and an oxygen sensor signal OS1 on line 58. The MAP signal is obtained with a conventional manifold absolute pressure sensor 60 responsive the pressure of the intake air in intake manifold 16, the RPM signal may be obtained from a conventional crankshaft or camshaft sensor, generally designated by the reference numeral 62, and the oxygen signal OS1 is obtained from a conventional wide-range or universal exhaust gas oxygen sensor 64 disposed in the exhaust gas stream upstream of the catalytic converter 46 in exhaust pipe 44. A second oxygen sensor 65 of the type having an output that switches or toggles between first and second states corresponding to lean and rich conditions of the sensed exhaust gas relative to a stoichiometric air/fuel ratio is disposed in the exhaust gas stream downstream of the catalytic converter 46, and is used for calibration of the wide-range sensor 64 as described below. The oxygen sensor 65 provides an output signal OS2 to ECM 52 on line 59.

In general, ECM 52 determines a base fuel pulse width as a function of the RPM and MAP signals, and other inputs such as temperature and barometric pressure. Alternatively, the base fuel pulse width may be determined based on a measure of mass air flow in the intake passage 12, using a mass air flow meter up-stream of throttle plate 14. The ECM 52 then adjusts the base fuel pulse width using previously learned closed-loop corrections, which are typically stored in a electrically-erasable non-volatile look-up table as a function of RPM and MAP. The closed-loop corrections for any given load condition are periodically updated based on air/fuel ratio error, where the wide range oxygen sensor 64 is used to measure the actual air/fuel ratio, and the air/fuel ratio error is computed according to the deviation of the actual ratio from a desired ratio. In practice, the output of oxygen sensor 64 is a voltage, and the ECM 52 utilizes a calibration look-up table such as depicted by the graph of FIG. 2 to determine an air/fuel ratio corresponding to the sensor voltage.

Calibration look-up table data such as depicted in FIG. 2 is empirically determined prior to installation of the sensor 64 in a vehicle engine. In many cases, the original calibration data is subsequently utilized during vehicle operation without any modification other than a stoichiometric offset. However, it is known that the operating characteristics of a wide range sensor such as the sensor 64 tend to drift, due to aging for example, and that the air/fuel ratio determined by ECM 52 will correspondingly differ from the actual air/fuel ratio if the look-up table is not re-calibrated. The above-referenced U.S. Pat. No. 6,227,033 to Kainz describes a method of recalibrating the table during a so-called “free air” state where the engine is decelerating with no fuel, but heretofore no technique has been known for enabling re-calibration of the table at any air/fuel ratio.

In general, the present invention provides a technique for enabling re-calibration of the table at any air/fuel ratio by utilizing sensor voltages recorded under stoichiometric and deceleration fuel cut-off conditions to determine first and second lump-sum parameters LSₗ, LSᵣ that describe lean and rich operating characteristics of the sensor, respectively, and utilizing such parameters to calculate the corresponding air/fuel ratio. In this way, ECM 52 can re-calibrate the look-up table at any air/fuel ratio.

In operation, a wide range exhaust gas sensor produces a pumping current Iₚ that is converted into an output voltage V. When the air/fuel ratio is lean (i.e., higher than the stoichiometric ratio), the pumping current Iₚ is given by:

$${I}_{p} = {CD}_{O2} ( \frac{P}{T} ) ( \frac{S}{L} ) L n ( \frac{1}{1 - \frac{{P}_{O2}}{P}} ) \qquad ( 1 )$$

In the above equation, C=4 F/R (with F being the Faraday constant and R being a gas constant), T is absolute temperature, P is the exhaust gas pressure, S is the total cross-sectional area of apertures or diffusion channels in the exhaust system, L is the average length of the apertures or diffusion channels, D_{O2} is the diffusivity of oxygen through the apertures or diffusion channels (which is generally dependent on temperature and pressure as well as on the diffusion medium), and P_{O2} is the partial pressure of oxygen in exhaust gas. If P_{O2}/P is small, equation (1) can be approximated by:

$${I}_{p} = C ( \frac{{D}_{O2}}{T} ) ( \frac{S }{L} ) {P}_{O2} \qquad ( 2 )$$

When the air/fuel ratio is rich (i.e., lower than the stoichiometric ratio), the pumping current Iₚ is given by:

$${I}_{p} = - {C}^{′} ( \frac{{D}_{R}}{T} ) ( \frac{S }{L} ) {P}_{R} \qquad ( 3 )$$

where C′=8 F/R, P_{R} is the partial pressure of reducing gases in exhaust gas, D_{R} is the diffusivity of the reducing gases through the apertures or diffusion channels of the exhaust system (which is generally dependent on temperature and pressure as well as on the diffusion medium).

It can be shown that the corresponding sensor output voltage V for the case of a lean air/fuel ratio is given by:

V=(LSₗ*Pⁿ*P_{O2})+Vₒ (4)

and for the case of a rich air/fuel ratio is given by:

V=(LSᵣ*Pⁿ*P_{R})+Vₒ (5)

In equations (4) and (5), LSₗ and LSᵣ are the lean and rich lump-sum parameters mentioned above, P is the exhaust pressure, n is a calibrated constant between zero and one, and Vₒ is the sensor output voltage when the exhaust gas is at the stoichiometric ratio. The exhaust pressure P can be measured, modeled, or estimated using an empirically calibrated look up table.

Since Vₒ can be calibrated during operation under stoichiometric operating conditions as taught by Kainz and others, the only unknowns in equation (4) at any lean air/fuel ratio operating point are the lump-sum parameter LSₗ and the partial pressure P_{O2} of oxygen. However, the partial pressure P_{O2} is known at a particular lean operating point, namely, deceleration fuel cut-off. Hence, equation (4) can be used to calculate the lump-sum parameter LSₗ as a function of known parameters V, Pⁿ, P_{O2} and Vₒ during deceleration fuel cut-off conditions. Also, once the change in LSₗ (that is, ΔLSₗ) is known, a corresponding change (ΔLSᵣ) in the rich operation lump-sum parameter LSᵣ can be closely approximated as:

ΔLSᵣ=(ΔLSₗ*LSᵣ)/LSₗ (6)

In other words, the percentage change in rich lump-sum parameter LSᵣ is assumed to be equivalent to the percentage change in lean lump-sum parameter LSₗ. The calculated change ΔLSᵣ, in turn, can be used to revise the rich lump sum parameter LSᵣ.

Since the normalized air/fuel ratio λ can be calculated as a function of P_{O2} for ratios higher than stoichiometry, the value of λ corresponding to any sensor voltage above Vo can be determined as a function of LS₁, Pⁿ and Vₒ. Similarly, since λ can be calculated as a function of P_{R} for ratios lower than stoichiometry, the value of λ corresponding to any sensor voltage below Vo can be determined as a function of LSᵣ, Pⁿ and Vₒ. In particular, if it is assumed that there is little air to fuel ratio mal-distribution, and the NOx emissions at the lean side and the unburned or partially burned hydrocarbon emissions at the rich side are omitted, the combustion reactions can be expressed as:

$${CH}_{y} {O}_{z} + λ ( 1 + \frac{y}{4} - \frac{z}{2} ) ( {O}_{2} + \frac{{Ϛ}_{N2}}{{Ϛ}_{O2}} {N}_{2} ) \\ = q ( {p}_{CO2} {CO}_{2} + {p}_{O2} {O}_{2} + {p}_{N2} {N}_{2} + {p}_{H2O} {H}_{2} O ) \qquad ( 7 )$$

for lean air/fuel ratios, and

$${CH}_{y} {O}_{z} + λ ( 1 + \frac{y}{4} - \frac{z}{2} ) ( {O}_{2} + \frac{{Ϛ}_{N2}}{{Ϛ}_{O2}} {N}_{2} ) \\ = q ( {p}_{CO2} {CO}_{2} + {p}_{CO} CO + {p}_{N2} {N}_{2} + \\ {p}_{H2O} {H}_{2} O + {p}_{H2} {H}_{2} ) \qquad ( 8 )$$

for rich air/fuel ratios. In the above equations, y and z are the ratios of hydrogen to carbon and oxygen to carbon, respectively, of the fuel, ζ_{N2}=0.791 and ζ_{O2}=0.209 are mole fractions of N₂ and O₂, respectively, in dry air, and q and pᵢ are the total number of moles of exhaust products and mole fraction of the ith exhaust component, respectively.

The normalized air/fuel ratio λ can be derived from equations (7) and (8) using atomic balance for each element as:

$$λ = \frac{1 + \frac{y}{4} - \frac{z}{2} + ( \frac{y}{4} - \frac{z}{2} ) {P}_{O2}}{( 1 + \frac{y}{4} - \frac{z}{2} ) ( 1 - \frac{{P}_{O2}}{{Ϛ}_{O2}} )} \qquad ( 9 )$$

for lean air/fuel ratios, and

$$λ = \frac{1}{1 + \frac{y}{4} - \frac{z}{2}} \frac{2 ( 1 + \frac{y}{4} - \frac{z}{2} ) - \frac{4}{3} ( 1 + \frac{y}{2} ) {P}_{CO}}{2 + \frac{4}{3} \frac{{Ϛ}_{N2}}{{Ϛ}_{O2}} {P}_{CO}} \qquad ( 10 )$$

for the rich air/fuel ratios. In equation (10), the equilibrium constant of water gas shift reaction, K, is assumed to be known, i.e.,

$$\frac{{p}_{CO} {p}_{H2O}}{{p}_{CO2} {p}_{H2}} = K \qquad ( 11 )$$

A value of 3.5 is commonly used for K. For conventional petroleum-based fuels, z=0, y≈1.85, and z is typically a small number even for oxygenated blends (for example, z=0.03 for a 9% ethanol added fuel) and does not significantly affect λ. More importantly, the re-calibration of Vₒ using the rear oxygen sensor 65 compensates small variations in fuel properties.

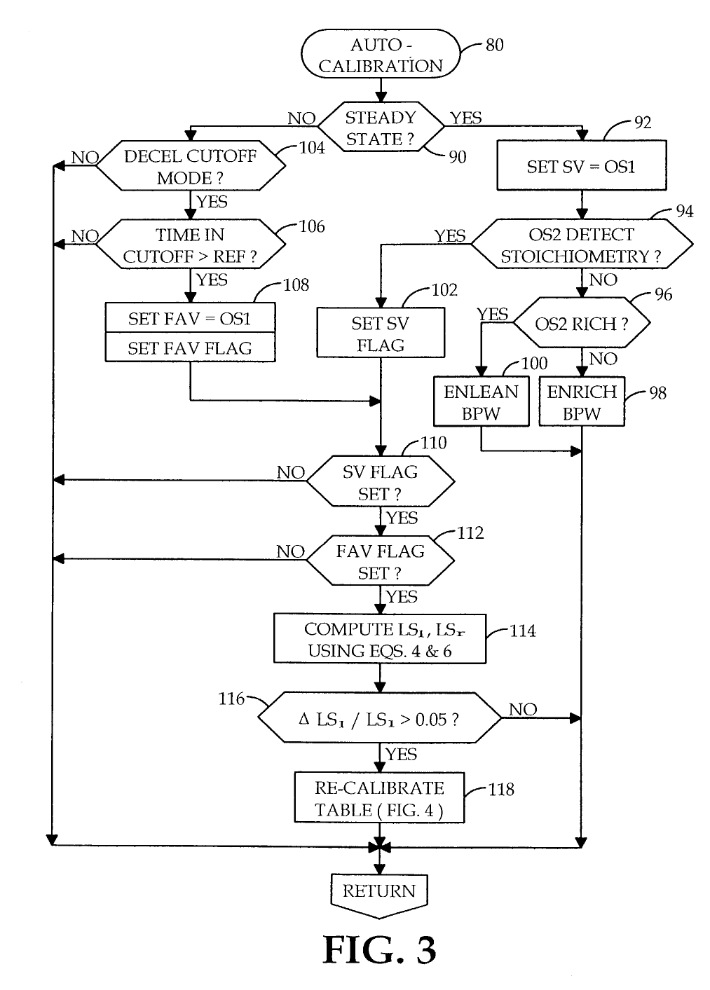

The flow diagram of FIG. 3 outlines an auto-calibration background routine periodically executed by ECM 52. The block 90 is first executed to determine if the engine 10 is in a steady state operating condition; this may be determined, for example, by detecting a condition of steady throttle and speed, and an engine temperature within specified limits. If the engine 10 is operating in steady state, the blocks 92 and 94 are executed to set the stoichiometric sensor voltage SV to the OS1 reading of wide-range oxygen sensor 64, and to determine if the OS2 reading of the switching oxygen sensor 65 confirms the presence of a stoichiometric air/fuel ratio. If the OS2 reading is not indicative of stoichiometry, the blocks 96-100 incrementally adjust the base pulse width BPW in a direction to drive the air/fuel ratio toward the stoichiometric switching point of oxygen sensor 65. Thus, if block 96 determines that the air/fuel ratio is lean relative to the stoichiometric ratio, the block 98 incrementally increases BPW to enrich the air/fuel ratio; conversely, if block 96 determines that the air/fuel ratio is rich relative to the stoichiometric ratio, the block 100 incrementally decreases BPW to enlean the air/fuel ratio. The air/fuel ratio will change accordingly, and if engine 10 is still operating in steady state (as determined at block 90), blocks 92-94 are re-executed to revise the stored value of SV based on the OS1 reading and to determine if the incremental fuel adjustment of the previous loop caused the OS2 reading of oxygen sensor 65 to indicate stoichiometric operation. So long as steady-state engine operation is maintained,-the BPW is repeatedly adjusted by blocks 98 or 100 until block 94 is answered in the affirmative. At such point, block 102 is executed to set the SV Flag, indicating that the stoichiometric sensor voltage SV has been determined.

With respect to the free-air sensor voltage FAV, the block 104 is first executed to determine if the engine 10 is in a condition of fuel cutoff, as may periodically occur during sustained high speed vehicle deceleration, depending on the design of the engine fuel control algorithms. If the engine 10 has been in a fuel cut-off condition for more than a reference time REF corresponding to the anticipated lag in response of the wide-range oxygen sensor 64, as determined at block 106, the block 108 is executed to set FAV to the OS1 reading of sensor 64 and to set the FAV Flag, indicating that the free air sensor voltage FAV has been determined.

Once either of the SV or FAV Flags have been set, the blocks 110 and 112 are executed to determine if both flags have been set. When both flags have been set, ECM 52 executes the block 114 to compute LS₁ and LSᵣ using equations (4) and (6). So long as the percentage change in LSₗ (that is, ΔLSₗ/LSₗ) is less than a threshold such as 5%, the block 116 is answered in the negative, and the current sensor voltage vs. air/fuel ratio table data is maintained. Otherwise, block 116 is answered in the affirmative, and ECM 52 executes block 118 to re-calibrate sensor voltage vs. air/fuel ratio table data.

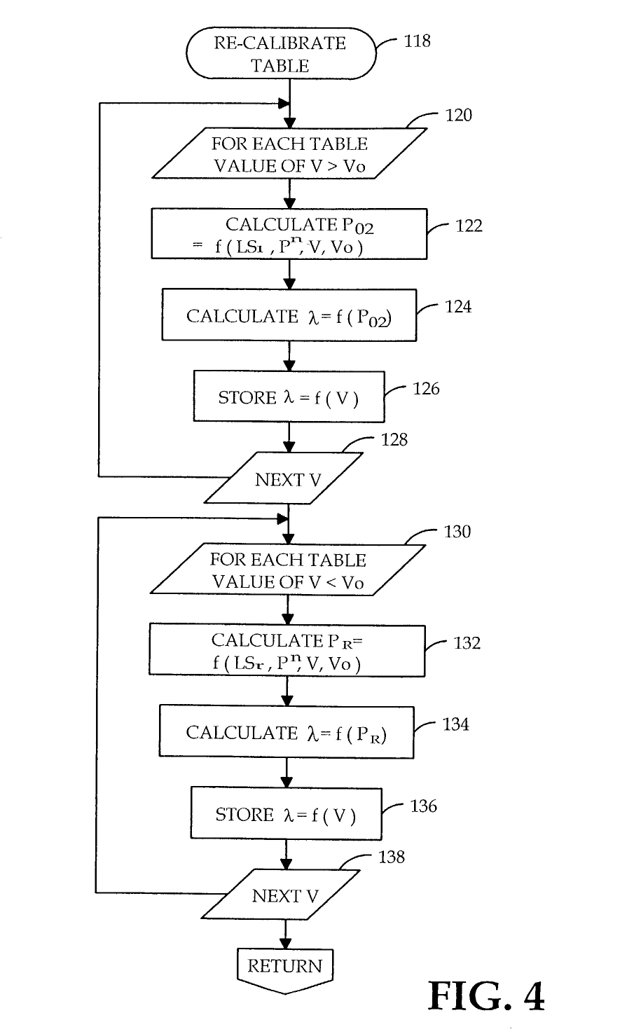

Referring to FIG. 4, the recalibration block 118 of FIG. 3 is set forth in further detail. The blocks 120, 122, 124, 126 and 128 calculate P_{O2} and λ for incremental values of sensor voltage V above Vₒ using equations (4) and (9), and store the computed λ values in the air/fuel ratio look-up table as a function of the corresponding sensor output voltage V. The blocks 130, 132, 134, 136 and 138 similarly calculate P_{R} and λ for incremental values of sensor voltage V below Vo using equations (5) and (10), and store the computed λ values in the air/fuel ratio look-up table as a function of the corresponding sensor output voltage V. Of course, the blocks 122 and 124 may be combined, as well as the blocks 132 and 134, since it is not necessary to know the values of P_{O2} and P_{R}, per se.

In summary, the present invention provides a method of automatically re-calibrating a stored relationship between air/fuel ratio and the output voltage of a wide-range exhaust gas oxygen sensor under any air/fuel ratio condition. The sensor is first calibrated under stoichiometric conditions to ensure that Vₒ is correct, and then the sensor voltage under free-air exhaust gas conditions is used to calculate lump sum parameters LSₗ, LSᵣ that describe lean and rich operating characteristics of the sensor, respectively. When the parameters change by at least at specified amount, they are used to re-calibrate the stored relationship.

While this invention has been described in reference to the illustrated embodiment, it is expected that various modifications in addition to those suggested above will occur to those skilled in the art. For example, the ECM 52 can simply calculate the air/fuel ratio λ as a function of the current sensor voltage V instead of using the air/fuel ratio look-up table, if desired. In this regard, it will be understood that the scope of this invention is not limited to the illustrated embodiment, and that sensor calibration methods incorporating such modifications may fall within the scope of this invention, which is defined by the appended claims.

1. A method of automatically recalibrating stored data relating air/fuel ratio to an output voltage of a wide range oxygen sensor disposed in an exhaust gas stream of an internal combustion engine, the method comprising the steps of:
determining a stoichiometric voltage according to a sensor output voltage that occurs when said engine is operating at a stoichiometric air/fuel ratio, and a free-air voltage according to a sensor output voltage that occurs when said engine is decelerating under a fuel cutoff condition;
calculating a lean lump sum parameter and a rich lump sum parameter of said sensor based on said free-air voltage and said stoichiometric voltage;
recalibrating the stored data for air/fuel ratios above the stoichiometric air/fuel ratio based on said lean lump sum parameter; and
recalibrating the stored data for air/fuel ratios below the stoichiometric air/fuel ratio based on said lump sum rich parameter.

2. The method set forth in claim 1, including the step of:
calculating the lean lump sum parameter as a function of said free-air voltage, said stoichiometric voltage, and known parameters of said exhaust gas that occur when said engine is decelerating under said fuel cutoff condition.

3. The method set forth in claim 2, including the step of:
determining a deviation of the calculated lean lump sum parameter from a previously obtained value of said lean lump sum parameter; and
calculating the rich lump sum parameter as a function of the determined deviation and a previously obtained value of said rich lump sum parameter.

4. The method set forth in claim 2, including the steps of:
determining a deviation of the calculated lean lump sum parameter from a previously obtained value of said lean lump sum parameter; and
recalibrating the stored data when the determined deviation is larger than a threshold.

5. The method set forth in claim 1, wherein the step of recalibrating the stored data for air/fuel ratios above the stoichiometric air/fuel ratio includes the steps of:
calculating an air/fuel ratio value for a given sensor output voltage above the determined stoichiometric voltage based on the determined stoichiometric voltage, the calculated lean lump sum parameter, and a pressure of said exhaust gas; and
revising a stored air/fuel ratio corresponding to the given sensor output voltage based on the calculated air/fuel ratio.

6. The method set forth in claim 1, wherein the step of recalibrating the stored data for air/fuel ratios below the stoichiometric air/fuel ratio includes the steps of:
calculating an air/fuel ratio value for a given sensor output voltage below the determined stoichiometric voltage based on the determined stoichiometric voltage, the calculated rich lump sum parameter, and a pressure of said exhaust gas; and
revising a stored air/fuel ratio corresponding to the given sensor output voltage based on the calculated air/fuel ratio.
